(19) United States
(12) Patent Application Publication
(10) Pub. No.: US 2013/0220970 A1
(43) Pub. Date: Aug. 29, 2013

(54) METHOD FOR FABRICATING TEMPLATE

(71) Applicant: Takeshi KOSHIBA, Mie-ken (JP)

(72) Inventor: Takeshi KOSHIBA, Mie-ken (JP)

(21) Appl. No.: 13/597,828

(22) Filed: Aug. 29, 2012

(30) Foreign Application Priority Data
Feb. 29, 2012 (JP) P2012-044804

(51) Int. Cl. B44C 1/22

(52) U.S. Cl. 216/12

(57) ABSTRACT

According to one embodiment, a method for fabricating a template, includes providing a mask pattern on a template substrate, processing the template substrate using the mask pattern as a mask so as to provide a first pattern on a first area in the template substrate and a second pattern on a second area which is located adjacent to the first area in the template, providing a first mask material on the template substrate so as to cover the first area, and processing the second area using the first mask material as a mask so as to lower a height of a surface of the second area than a height of a surface of the first area.

### CROSS REFERENCE TO RELATED APPLICATION

This application is based upon and claims the benefit of priority from prior Japanese Patent Application No. 2012-044804, filed on Feb. 29, 2012, the entire contents of which are incorporated herein by reference.

### FIELD

Exemplary embodiments described herein generally relate to a method for fabricating a template which is used in processing a semiconductor device, a hard disc, a photo array or the like.

### BACKGROUND

Recently, imprint technology has been focused in device fabrication such as a semiconductor device, an HDD, a photo array and the like. In imprint technology, a pattern formed on the template is transferred on a substrate to be transferred such as a silicon substrate or the like.

In an imprint method, a template, on which a groove pattern with a concave shape, is impressed on an organic material coated on a substrate to be transferred, so that the organic material is filled in the groove pattern of the template. After hardening the organic material by photo irradiation or the like, the template is released from the organic material in the imprint method, so that the organic material pattern is formed on the substrate.

The concave shape pattern, which is utilized to provide a circuit pattern, is formed on the template in the imprint method. A surface of an area, in which the pattern is formed, has a different structure in height from a surface of a periphery area. Accordingly, the structure of the pattern area has convexity compared to the periphery area.

Such the structure is utilized after the device circuit pattern is formed on a prescribed area in the substrate to be transferred as mentioned below. When the template is contacted on an adjacent area of the substrate to transfer the device circuit pattern, it can be avoided that the pattern transferred on the prescribed area is contacted to the template to cause damage in the template.

In fabricating the template, a template area exposed in an opening of a mask pattern is etched to form a concave-shape like a groove pattern on a template substrate after the mask pattern is formed on the template substrate.

However, an opening of a mask pattern formed on the template has been recently designed to be finer and closer with accompanying miniaturization of an electron device such as a semiconductor device or the like. Accordingly, a closely or sparsely arranged state influences on etching accuracy. In such a manner, a size of the template pattern after etching may be shifted from the desired size.

### BRIEF DESCRIPTION OF THE DRAWINGS

FIGS. 1A-1E are cross sectional views showing a method for fabricating a template according to an embodiment; and

FIGS. 2A-2B are a plane view and a cross sectional view, respectively, showing a structure of the template according to the embodiment.

### DETAILED DESCRIPTION

According to one embodiment, a method for fabricating a template includes providing a mask pattern on a template substrate, processing the template substrate using the mask pattern as a mask so as to provide a first pattern on a first area in the template substrate and a second pattern on a second area which is located adjacent to the first area in the template, providing a first mask material on the template substrate so as to cover the first area, and processing the second area using the first mask material as a mask so as to lower a height of a surface of the second area than a height of a surface of the first area.

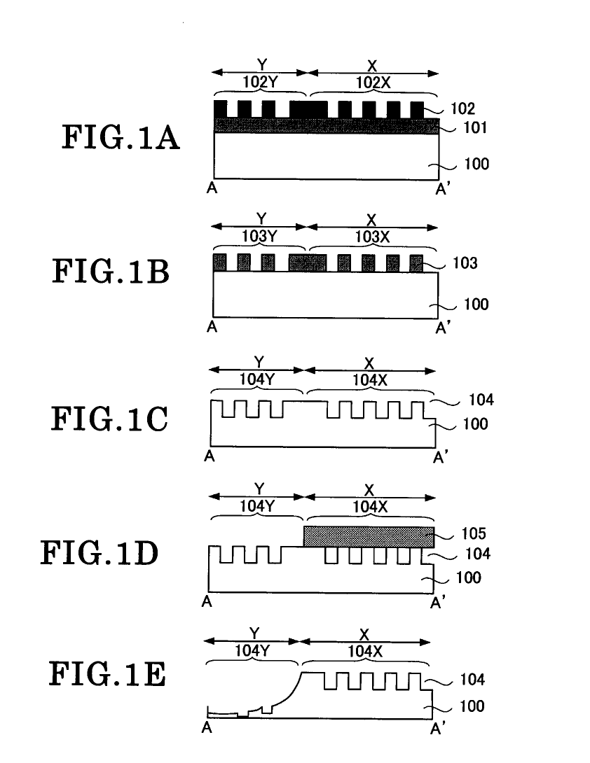

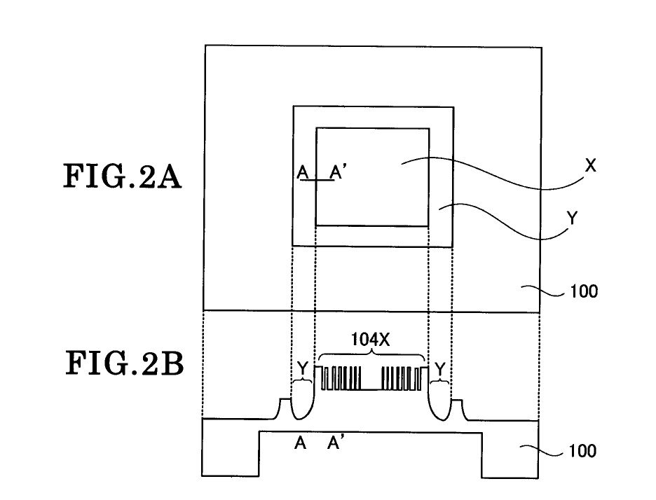

First, a method for fabricating a pattern according to an embodiment will be described below in detail with reference to FIG. 1 and FIG. 2.

### Embodiment

Processing steps for fabricating a template according to the embodiment is described below in detail with reference to FIG. 1 and a structure of the template according to the embodiment is described below in detail with reference to FIG. 2.

FIGS. 1A-1E are cross sectional views in processing steps showing the method for fabricating the template and FIGS. 2A-2B are a plane view and a cross sectional view, respectively, showing a structure of the template.

FIGS. 1A-1E are the cross sectional views of processing steps locally extracting along A-A cross-section of the template.

As shown in FIG. 1A, a mask material 101 is provided on a template substrate 100, and a resist pattern 102 is provided on the mask material 101. A material of the template substrate 100 is composed of quartz, sapphire or the like which has transparency. The template substrate 100 includes a first area X and a second area Y. The first area X is a device circuit pattern area in which a concave shape pattern is provided. The concave shape pattern is provided to form device circuit pattern area on a substrate to be transferred such as a silicon substrate or the like. The second area Y is a periphery area which is located at a periphery of the device pattern area. The cross sectional view of processing steps locally shows a boundary between the first area X and the second area Y in the template substrate 100.

The resist pattern 102 is formed by using electron-beam writing equipment generally used. After a resist film is coated on the mask material 101, a desired pattern is written in the rest film by using electron-beam writing equipment. Furthermore, the resist film is developed using a developer to form the resist pattern 102.

A resist pattern 102 includes a first resist pattern 102X and a second resist pattern 102Y, respectively, provided in the first area X and in the second area Y. After a pattern is written in the resist film by electron beam writing equipment, the resist film is collectively developed. In such a manner, the first resist pattern 102X and the second resist pattern 102Y are provided, respectively.

In a comparative case that the first resist pattern 102X is provided without the second resist pattern 102Y, an evaluation on a pattern after being formed is described below. Of course, the second resist pattern 102Y is formed adjacent to the first resist pattern 102X in the embodiment. In the comparative case, a pattern of the farthest edge portion in the first resist pattern 102X is different in a pattern environment from a pattern of an inner portion, a center portion for example, in the first resist pattern 102X. The pattern environment of the prescribed pattern is determined based on a size, a pitch, which means a pattern interval, a density, a total length of pattern peripheries or shift degrees of those parameters. A density of a pattern located at farthest edge portion of the first resist pattern 102X is largely varied because an adjacent pattern is not located outside the pattern. On the other hand, a density of a pattern located near the center portion is small varied because an adjacent pattern is located outside and inside the pattern.

In developing a resist pattern, it is a key factor to precisely form a pattern as designed whether or not a pattern environment with respect to a pattern to be formed in the resist film by the developing is unified. Accordingly, it is difficult to form a pattern near the edge portion as designed when both a resist pattern at the edge portion with larger variation of the pattern density and a resist pattern near the center portion with smaller variation of the pattern density in the developing.

On the other hand, the second resist pattern 102Y is provided on the mask material 101 to be located adjacent to the first resist pattern 102X in the method for fabricating the template according to the embodiment. As a result, the second resist pattern 102Y is also provided outside a pattern at the edge of the first resist pattern 102X, so that the variation of the pattern density is smaller than that of the comparative case described above. As comparing to the comparative case, variation of the pattern density of the edge portion in the first resist pattern 102X approaches to that of the center portion in the first resist pattern 102X according to the embodiment, so that offset from the designed size can be suppressed when both the patterns are formed in the development.

In the process mentioned above, the second resist pattern 102Y can be formed as a state where the pattern environment of the edge of the first resist pattern 102X approach to the pattern environment of the center of the first resist pattern 102X. When the first resist pattern 102X is set to be a cycle pattern having prescribed size and interval, the second resist pattern 102Y can be also set to be a cycle pattern having the same size and interval, for example. In such a case, the pattern of the farthest edge portion in the first resist pattern 102X is surrounded by the cycle pattern having the identity size and interval in the center pattern. Here, identity includes design identity of each resist pattern. In such a manner, the pattern of the edge portion of the first resist pattern 102X has approximately identity with the pattern of the center portion of the first resist pattern 102X, so that all of the first resist pattern 102X can be formed as the same size as designed.

After forming the resist pattern 102 as described above, the mask material 101 is etched using the resist pattern 102 as a mask to form the mask pattern 103 in the mask material 101 as shown in FIG. 1B. A pattern provided by processing the mask material 101 using the first resist pattern 102X as the mask is named as a first mask pattern 103X and a pattern provided by processing the mask material 101 using the first resist pattern 102Y as the mask is named as a second mask pattern 103Y. Successively, the resist pattern 102 is removed by an ashing process. A material having selective ratio to the template substrate 100, Cr, Mo or the like, for example, is utilized as the mask material 101 which can be constituted with a mono structure or a multi-level structure.

When an underlying film is dry-etched using the resist pattern or the like as a mask to collectively process a pattern, it is dependent on a pattern environment of a prescribed pattern used as the mask in applying dry etching to the underlying film whether or not a pattern to be formed in the underlying film is formed as the same size as designed. Here, the pattern environment of the prescribed pattern is determined based on a size, a pitch, which means a pattern interval, a density, a total length of pattern peripheries or shift degrees of those parameters.

When each opening in a pattern included in the resist pattern, for example, has a pattern environment which is different each other and an underlying film is etched by dry etching using the resist pattern as a mask, it may be difficult that all of patterns in the underlying film corresponding to each pattern is provided the same size and shape as designed. On the other hand, when a pattern environment of each pattern is similar each other, the pattern of the underlying film corresponding to each pattern can be easily provided the same size and shape as designed.

The second resist pattern 102Y is provided to be located adjacent to the first resist pattern 102X in the method for fabricating the template according to the embodiment. Accordingly, variation of a density of a pattern which located at the farthest portion of a side of the second resist pattern 102Y (the outer side) and a pattern density of a pattern which is located at the inner side in the first resist pattern 102X can be approximated.

Therefore, when the mask pattern 103 is provided by etching the underlying film using the resist pattern 102 as the mask, all of the patterns constituting the mask pattern 103 can be provided as the same size and shape as designed.

As shown in FIG. 1C, the template substrate 100 is processed using the mask pattern 103 as a mask using etching to provide a template pattern 104 with a concave pattern in the template substrate 100. A depth of each groove is approximately 60 nm. Subsequently, the mask pattern 103 is removed by etching.

A pattern provided by processing the template substrate 100 using the first mask pattern 103X as the mask is named as a first template pattern 104X and a pattern provided by processing the template substrate 100 using the second mask pattern 103Y as the mask is named as a second template pattern 104Y. The template pattern 104X is provided for forming the device circuit pattern area. The second template pattern 104Y is a dummy pattern which is not transferred to the substrate or the like in the imprint method, and the dummy pattern is designed to improve size accuracy at the edge portion of the first template pattern 104X.

As similar to the etching process of the mask material 101 described using FIG. 1B, a pattern environment of each pattern constituting the mask pattern 103 is also approximated in the etching process of the template substrate 100. As a result, each pattern constituting the template pattern 104 can be provided as the same size and shape as designed.

Successively, a resist film is coated on the template substrate 100, and a resist pattern is provided as a mask material 105 by photolithography to cover the first template pattern 104X and to expose the second template pattern 104Y as shown in FIG. 1D.

Furthermore, a second area Y in which the second template pattern 104Y is formed are etched by wet etching as shown in FIG. 1E. In such a manner, a surface of a first area X, in which the first template pattern 104X is formed in the template substrate 100, becomes higher than a surface of the second area Y.

When imprint method is performed using the template having such a step structure, after transferring a pattern in a prescribed area of a silicon wafer, the pattern is transferred also in other area adjacent to the prescribed area by contacting the template to the other area. In such a case, it can be avoided that the pattern already transferred in the prescribed area is contacted to the template to be damaged.

In the method for fabricating the template according to the embodiment, the template substrate 100 is grooved into a depth of 60 μm by wet etching. In this case, an area near a bottom of the second template pattern 104Y is leaved on the surface of the template substrate 100 after wet etching. Further, the template substrate 100 may be grooved deeper by wet etching as well. In this case, the second template pattern 104Y on the template substrate 100 can be removed.

The template can be fabricated by the method for fabricating the template according to the embodiment.

In the method for fabricating the template according to the embodiment, a pattern environment of each pattern constituting the first resist pattern 102X and the first mask pattern 103X are unified by providing the second resist pattern 102Y and the second mask pattern 103Y adjacent to the first resist pattern 102X and the first mask pattern 103X, respectively. Therefore, both the first mask pattern 103X and the first template pattern 104X can be provided as the same size and shape as designed when the first mask pattern 103X and the first template pattern 104X are provided through each etching process.

Successively, a structure of the template fabricated by the method according to the embodiment is described as a reference to FIGS. 2A, 2B.

As shown in FIG. 2A, both the first area X, in which the template substrate 100 and the first template pattern 104X is formed, and the second area Y which is designed as a periphery area of the first area X are formed as rectangular shapes. The first area X, in which the first template pattern 104X is formed, is located to be surrounded by the second area Y.

As shown in FIG. 2B, a surface of the second area Y is positioned lower than a surface of the first area X.

A new template can be replicated by using the template fabricated by the imprint method according to the embodiment.

A first template substrate having the template pattern 104X and the second template pattern 104Y is fabricated by the fabricating processes as shown in FIGS. 1A-1C. Successively, a second template substrate is prepared and a filling material is coated on the second template substrate. The first template substrate is contacted to the filling material to fill the filling material into the first template pattern 104X and the second template pattern 104Y and the filling material is harden by photo irradiation. The first template substrate is released from the second template substrate to form a pattern by the filling material on the second template substrate. The second template substrate is etched using the filling material as a mask to form a template pattern having a groove shape on the second template substrate. As the filling material patterns are provided both a first area and a second area adjacent to the first area, a size variation from a design size in a template pattern between an edge portion and a center portion can be prevented.

As shown in FIGS. 1D, 1E, a surface of the second area in the template substrate is grooved by selectively etching the second area while covering the first area by a resist pattern.

As mentioned above, the template can be further replicated by the imprint method. In this case, the filling material is provided both the first area and the second area. As a result, a pattern environment of a pattern in the edge portion of the filling material pattern in the first area and a pattern environment of a pattern in the center portion of the filling material pattern in the first area are approximated each other. Consequently, when the template pattern is provided by etching the template substrate, each pattern of the template pattern provided in the first pattern can be provided as the same size and shape as designed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and variations in the form of the embodiments described herein may be made without departing from the spirit of the inventions. The accompanying claims and their equivalents are intended to cover such forms or modifications as would fall within the scope and spirit of the inventions.

What is claimed is:

1. A method for fabricating a template, comprising:
providing a mask pattern on a template substrate;
processing the template substrate using the mask pattern as a mask so as to provide a first pattern on a first area in the template substrate and a second pattern on a second area which is located adjacent to the first area in the template;
providing a first mask material on the template substrate so as to cover the first area; and
processing the second area using the first mask material as a mask so as to lower a height of a surface of the second area to a height of a surface of the first area.

2. The method of claim 1, wherein
the first area is surrounded by the second area in the template.

3. The method of claim 1, wherein
the second pattern is removed in the processing the second area.

4. The method of claim 1, wherein
wet etching is performed in the processing the second area.

5. The method of claim 1, wherein
a size of the first pattern is the same as a size of the second pattern.

6. The method of claim 1, wherein
a pitch of the first pattern is the same as a pitch of the second pattern.

7. The method of claim 1, wherein
the first pattern is provided as a circuit pattern and the second pattern is provided as a dummy pattern.

8. The method of claim 1, wherein
the providing the mask pattern comprises
providing a second mask material on the template substrate,
providing a resist on the second mask material,
processing the resist so as to provide a resist pattern in the resist,
processing the second mask material using the resist having the resist pattern as a mask so as to transfer the resist pattern into the second mask material, and
removing the resist pattern.

9. The method of claim 1, further comprising:
removing the mask pattern, after processing the template substrate so as to provide the first pattern and the second pattern, before providing the first mask material.

10. A method for fabricating a template, comprising:
providing a mask pattern on a first template substrate;
processing the first template substrate using the mask pattern as a mask so as to provide a first pattern in a first area in the first template substrate and a second pattern in a second area adjacent to the first area in the first template substrate;
coating a filling material on a second template substrate;
contacting the first template substrate to the second template substrate on which the filling material is coated so as to fill the filling material into the first pattern and the second pattern;
irradiating light to the filling material so as to harden the filling material;
releasing the first template substrate from the second template substrate;
processing the second template substrate using the filling material as a mask so as to provide a third pattern in a third area and a fourth pattern in a fourth area adjacent to the third pattern in the second template substrate;
providing a first mask to cover the third area; and
processing the fourth area using the first mask as a mask so as to decrease a height of a surface of the fourth area to a height of a surface of the third area.

11. The method of claim 10, wherein
the first area of the first template substrate is surrounded by the second area and the third area of the second template substrate is surrounded by the fourth area.

12. The method of claim 10, wherein
the fourth pattern is removed in the processing the fourth area.

13. The method of claim 12, wherein
wet etching is performed in the processing the second area.

14. A method of claim 10, wherein
a size of the first pattern is the same as a size of the second pattern, and size of the third pattern is the same as a size of the fourth pattern.

15. The method of claim 10, wherein
a pitch of the first pattern is the same as a pitch of the second pattern, and a pitch of the third pattern is the same as a pitch of the fourth pattern.

16. The method of claim 10, wherein
the first pattern, the second pattern, the third pattern and the fourth pattern have the same size and interval.

17. A method of claim 10, wherein
the first pattern and the third pattern are provided as circuit patterns and the second pattern and the fourth pattern are provided as dummy patterns, respectively.

18. The method of claim 10, wherein
the providing the mask pattern comprises
providing a second mask material on the first template substrate,
providing a resist on the second mask material,
processing the resist so as to provide a resist pattern in the resist,
processing the second mask material using the resist having the resist pattern to transfer the resist pattern into the second mask material, and
removing the resist pattern.

19. The method of claim 10, further comprising:
removing the mask pattern, after processing the first template substrate so as to provide the first pattern and the second pattern, before coating the filling material.

20. The method of claim 10, further comprising:
removing the filing material, after processing the second template substrate so as to provide the third pattern and the fourth pattern, before the providing the first mask material.
